(19) United States
(12) Patent Application Publication
(10) Pub. No.: US 2025/0070899 A1
(43) Pub. Date: Feb. 27, 2025

(54) INTERFERENCE INFORMATION OUTPUTTING DEVICE, INTERFERENCE INFORMATION OUTPUTTING METHOD, INTERFERENCE INFORMATION OUTPUTTING SYSTEM, AND RECORDING MEDIUM

(71) Applicant: NEC Corporation, Minato-ku, Tokyo (JP)

(72) Inventor: Masato KITA

(73) Assignee: NEC Corporation, Minato-ku, Tokyo (JP)

(21) Appl. No.: 18/729,151

(22) PCT Filed: Feb. 2, 2022
(86) PCT No.: PCT/JP2022/003954

§ 371 Date: Jul. 15, 2024

(51) Int. Cl. H04B 17/345; H04W 24/08

(52) U.S. Cl. CPC H04B 17/345; H04W 24/08

(57) ABSTRACT

An interference information outputting device receives signal information that is information relating to quality of a reception signal being the wireless signal received by a wireless reception means, estimates whether radio interference occurs at a location position at which the wireless reception means is located, based on an estimation condition being a condition that is fulfilled when radio interference occurs, outputs interference information being information relating to radio interference, and further calculates a reliability degree indicating a degree of accuracy of the estimation when a result of the estimation is affirmative. The estimation condition includes a condition relating to the signal information. The interference information includes information relating to the location position and information relating to the result of the estimation, and includes information relating to the reliability degree when the result of the estimation is affirmative.

### TECHNICAL FIELD

The present invention relates to an interference information outputting device and the like.

### BACKGROUND ART

In wireless communication, one of factors that reduce a throughput is radio interference.

When radio interference occurs, and a throughput is reduced, quality of services to be provided via wireless communication may be degraded. Examples of the degradation of service quality include disruption in a video or audio being reproduced, degradation of control accuracy for remote control, and the like.

Thus, when radio interference occurs, it is desired that a measure against radio interference be taken for resolving the radio interference.

However, reduction in throughput may be caused by a factor other than radio interference. Thus, when a measure against radio interference is taken, an investigation on whether radio interference occurs is first required.

In general, reduction in throughput is detected when degradation of service quality occurs. Further, in general, an investigator visits a site where the degradation of service quality occurs, and the investigator conducts investigation on whether radio interference occurs, by checking a radio status and the like in the periphery.

Further, the related-art techniques include a technique described in PTL 1.

### CITATION LIST

### Patent Literature

PTL 1: Japanese Unexamined Patent Application Publication No. 2021-044714

### SUMMARY OF INVENTION

### Technical Problem

However, in a general method of investigating radio interference as described above, it is difficult to rapidly determine whether degradation of service quality is caused by radio interference. As a result, it takes time to take a measure against radio interference. Thus, it is desired that determination on whether the degradation of service quality is caused by radio interference be facilitated more.

In view of the above-mentioned problem, an object of the present invention is to provide an interference information outputting device and the like capable of outputting information for facilitating determination on whether degradation of service quality is caused by radio interference.

### Solution to Problem

According to one aspect of the present invention, an interference information outputting device is connected to a wireless reception means for receiving a wireless signal, the interference information outputting device including: an information reception means for receiving signal information from the wireless reception means, the signal information being information relating to quality of a reception signal being the wireless signal received by the wireless reception means; an estimation means for estimating whether radio interference occurs at a location position at which the wireless reception means is located, based on an estimation condition being a condition that is fulfilled when radio interference occurs; and an output means for outputting interference information being information relating to radio interference, in which, when a result of the estimation is affirmative, the estimation means further calculates a reliability degree indicating a degree of accuracy of the estimation, the estimation condition includes a condition relating to the signal information, and the interference information includes information relating to the location position and information relating to the result of the estimation, and includes information relating to the reliability degree when the result of the estimation is affirmative.

Further, according to another aspect of the present invention, an interference information outputting method is for an interference information outputting device that is connected to a wireless reception means for receiving a wireless signal, the interference information outputting method including: receiving signal information from the wireless reception means, the signal information being information relating to quality of a reception signal being the wireless signal received by the wireless reception means; estimating whether radio interference occurs at a location position at which the wireless reception means is located, based on an estimation condition being a condition that is fulfilled when radio interference occurs, the estimation condition including a condition relating to the signal information; further calculating a reliability degree indicating a degree of accuracy of the estimation when a result of the estimation is affirmative; and outputting interference information being information relating to radio interference, in which the interference information includes information relating to the location position and information relating to the result of the estimation, and includes information relating to the reliability degree when the result of the estimation is affirmative.

Further, according to another aspect of the present invention, an interference information outputting program recorded in a computer-readable recording medium causes a computer to achieve: an information reception function of receiving signal information being information relating to quality of a reception signal being a wireless signal received by a wireless reception means for receiving a wireless signal; an estimation function of estimating whether radio interference occurs at a location position at which the wireless reception means is located, based on an estimation condition being a condition that is fulfilled when radio interference occurs; and an output function of outputting interference information being information relating to radio interference, in which, when a result of the estimation is affirmative, the estimation function further calculates a reliability degree indicating a degree of accuracy of the estimation, the estimation condition includes a condition relating to the signal information, and the interference information includes information relating to the location position and information relating to the result of the estimation, and includes information relating to the reliability degree when the result of the estimation is affirmative.

Further, according to another aspect of the present invention, an interference information outputting system includes: an information reception means for receiving, from a wireless reception means, signal information being information relating to quality of a reception signal being a wireless signal received by the wireless reception means for receiving a wireless signal; an estimation means for estimating whether radio interference occurs at a location position at which the wireless reception means is located, based on an estimation condition being a condition that is fulfilled when radio interference occurs; and an output means for outputting interference information being information relating to radio interference, in which, when a result of the estimation is affirmative, the estimation means further calculates a reliability degree indicating a degree of accuracy of the estimation, the estimation condition includes a condition relating to the signal information, and the interference information includes information relating to the location position and information relating to the result of the estimation, and includes information relating to the reliability degree when the result of the estimation is affirmative.

### Advantageous Effects of Invention

According to the present invention, information for facilitating determination on whether degradation of service quality is caused by radio interference can be output.

### BRIEF DESCRIPTION OF DRAWINGS

FIG. 1 is a diagram illustrating a configuration example of an interference information outputting device according to a first example embodiment of the present invention.

FIG. 2 is a diagram illustrating an example of an operation flow of the interference information outputting device according to the first example embodiment of the present invention.

FIG. 3 is a diagram illustrating a configuration example of a system including an interference information outputting device according to a second example embodiment of the present invention.

FIG. 4 is a diagram illustrating a configuration example of the interference information outputting device according to the second example embodiment of the present invention.

FIG. 5 is a diagram illustrating another configuration example of the interference information outputting device according to the second example embodiment of the present invention.

FIG. 6 is a diagram illustrating another configuration example of the interference information outputting device according to the second example embodiment of the present invention.

FIG. 7 is a diagram of an image that the interference information outputting device according to the second example embodiment of the present invention causes a display apparatus to display.

FIG. 8 is a diagram of an image that the interference information outputting device according to the second example embodiment of the present invention causes the display apparatus to display.

FIG. 9 is a diagram of an image that the interference information outputting device according to the second example embodiment of the present invention causes the display apparatus to display.

FIG. 10 is a diagram illustrating an example of an operation flow of the interference information outputting device according to the first example embodiment of the present invention.

FIG. 11 is a diagram illustrating a hardware configuration example of each of the example embodiments of the present invention.

### EXAMPLE EMBODIMENT

### First Example Embodiment

A first example embodiment of the present invention is described.

One specific example of an interference information outputting device 10 of the first example embodiment is an interference information outputting device 20 of a second example embodiment, which is described later.

First, with reference to the drawings, a configuration of the interference information outputting device 10 according to the first example embodiment of the present invention is described.

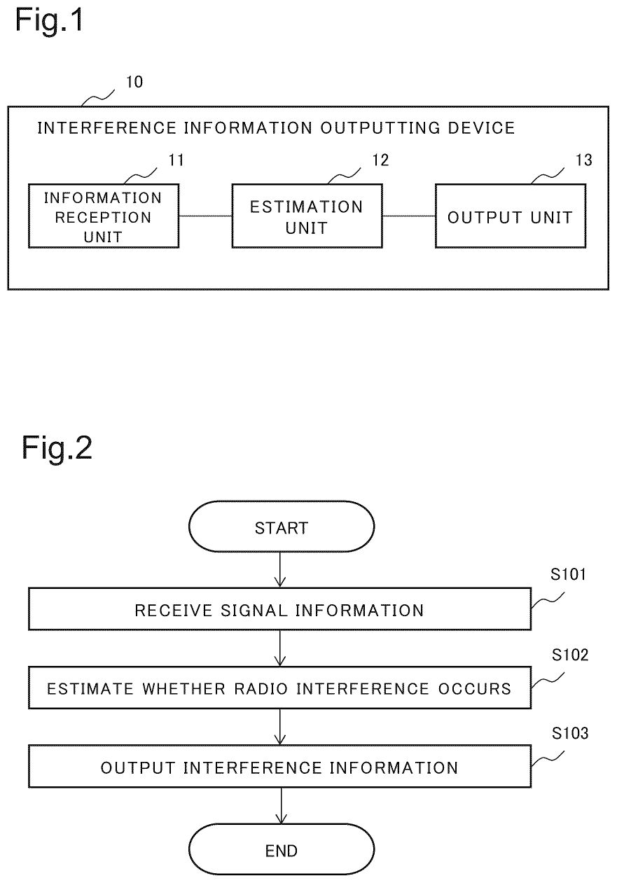

FIG. 1 illustrates a configuration example of the interference information outputting device 10 according to the present example embodiment. The interference information outputting device 10 includes an information reception unit 11, an estimation unit 12, and an output unit 13.

The information reception unit 11 receives signal information from a wireless reception means. The signal information is information relating to quality of a reception signal. Herein, the reception signal is a wireless signal being received by the wireless reception means for receiving a wireless signal.

The estimation unit 12 executes estimation on whether radio interference occurs at a location position at which the wireless reception means is located. The estimation unit 12 executes the estimation, based on an estimation condition. The estimation condition is a condition that is fulfilled when radio interference occurs. Further, the estimation condition includes a condition relating to the signal information. Further, the estimation unit 12 further calculates a reliability degree indicating a degree of accuracy of the estimation when a result of the estimation is affirmative.

The output unit 13 outputs interference information being information relating to radio interference. The interference information includes information relating to the location position and information relating to the result of the estimation, and includes information relating to the reliability degree when the result of the estimation is affirmative.

Next, with reference to the drawing, an operation flow of the interference information outputting device 10 according to the first example embodiment of the present invention is described.

FIG. 2 illustrates an example of the operation flow of the interference information outputting device 10 according to the present example embodiment.

The information reception unit 11 receives the signal information (step S101).

The estimation unit 12 executes the estimation on whether radio interference occurs at the location position at which the wireless reception means is located. Further, the estimation unit 12 further calculates the reliability degree indicating a degree of accuracy of the estimation when the result of the estimation is affirmative (step S102).

Further, the output unit 13 outputs the interference information (step S103).

As described above, in the first example embodiment of the present invention, the interference information outputting device 10 includes the information reception unit 11, the estimation unit 12, and the output unit 13. The information reception unit 11 receives the signal information. The signal information is the information relating to quality of the reception signal being the wireless signal being received by the wireless reception means for receiving a wireless signal. The estimation unit 12 executes the estimation on whether radio interference occurs at the location position at which the wireless reception means is located. Further, the estimation unit 12 executes the estimation, based on the estimation condition. The estimation condition is a condition that is fulfilled when radio interference occurs. Further, the estimation condition includes the condition relating to the signal information. Further, the estimation unit 12 further calculates the reliability degree indicating a degree of accuracy of the estimation when the result of the estimation is affirmative. The output unit 13 outputs the interference information being information relating to radio interference. The interference information includes the information relating to the location position and the information relating to the result of the estimation, and includes the information relating to the reliability degree when the result of the estimation is affirmative. In this manner, the interference information outputting device 10 outputs the information relating to the result of the estimation on whether radio interference occurs at the location position of the wireless reception means and the information relating to the reliability degree of the estimation. The information relating to the estimation result is output from the interference information outputting device 10, and hence an investigator can easily determine whether the degradation of service quality is caused by radio interference by referring to the information being output. Further, the information being output from the interference information outputting device 10 includes the information relating to the reliability degree of the estimation, and hence determination by an investigator is facilitated more. Thus, the information for facilitating determination on whether the degradation of service quality is caused by radio interference can be output.

### Second Example Embodiment

Next, the interference information outputting device 20 according to the second example embodiment of the present invention is described. One specific example of the interference information outputting device 10 of the first example embodiment is the interference information outputting device 20 of the second example embodiment.

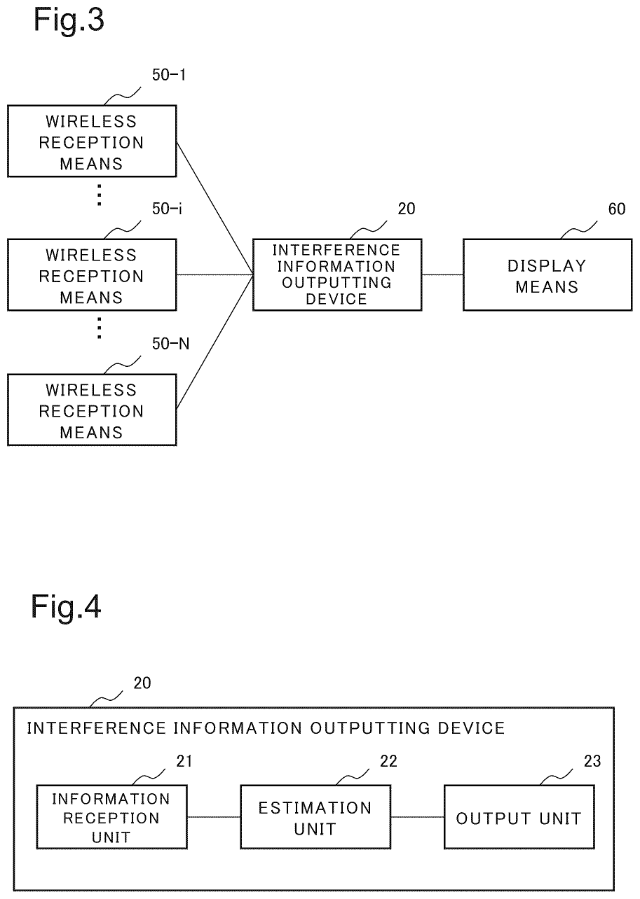

First, FIG. 3 illustrates a configuration example of a system including the interference information outputting device 20 according to the present example embodiment. The interference information outputting device 20 is mutually connected to a wireless reception means 50-i (i is an integer equal to one or more and equal to or less than N). Further, the interference information outputting device 20 is mutually connected to a display means 60.

The wireless reception means 50-i receives the wireless signal. Further, the wireless reception means 50-i outputs the signal information to the interference information outputting device 20. The signal information is the information relating to quality of the reception signal. The reception signal is the wireless signal being received by the wireless reception means 50-i.

The wireless reception means 50-i may be installed in a fixed manner, or may be movable. Further, a communication method for outputting the signal information from the wireless reception means 50-i to the interference information outputting device 20 may be a wired method or a wireless method.

The signal information is information that is used by the interference information outputting device 20 for estimating whether radio interference occurs. Specific examples of the signal information are described later.

The display means 60 is a machine interface such as a display functioning as an output device. The display means 60 displays an image. In the present example embodiment, it is assumed that the interference information outputting device 20 outputs the interference information to the display means 60. However, an output destination of the interference information may be freely selected. The interference information outputting device 20 may output the interference information to an output destination other than the display means 60. The interference information is described later.

Next, FIG. 4 illustrates a configuration example of the interference information outputting device 20 according to the present example embodiment. The interference information outputting device 20 according to the present example embodiment includes an information reception unit 21, an estimation unit 22, and an output unit 23.

The information reception unit 21 receives the signal information from the wireless reception means 50-i. The signal information is the information relating to quality of the reception signal that is received by the wireless reception means 50-i. The signal information includes wireless information being information relating to wireless characteristics of the reception signal and reception information being information relating to quality of a reception status of the reception signal. For example, the wireless information includes a reception signal level, an arrival direction of the reception signal, an arrival direction of an interference wave, and the like. Further, for example, the reception information includes a throughput, a packet error rate (PER), a bit error rate (BER), a signal to interference plus noise ratio (SINR), and the like.

The estimation unit 22 executes the estimation on whether radio interference occurs at the location position at which the wireless reception means 50-i is located. Hereinafter, in some cases, estimation on whether radio interference occurs at the location position of the wireless reception means 50-i is simply referred to as estimation.

The estimation unit 22 executes the estimation, based on the estimation condition. The estimation condition is a condition that is fulfilled when radio interference occurs. Further, the estimation condition includes a condition relating to the signal information being received from the wireless reception means 50-i. When the estimation condition is fulfilled, the estimation unit 22 estimates that radio interference occurs. Further, when the estimation condition is not fulfilled, the estimation unit 22 estimates that radio interference does not occur.

Further, when the result of the estimation is affirmative, in other words, when radio interference is estimated to occur, the estimation unit 22 further executes the calculation of the reliability degree. The reliability degree indicates the degree of accuracy of the estimation. A method of estimating radio interference and a method of calculating the reliability degree are described later.

The output unit 23 outputs the interference information being information relating to radio interference. The interference information includes the information relating to the result of the estimation being executed by the estimation unit 22 and the information relating to the location position of the wireless reception means 50-i. Further, when the result of the estimation is affirmative, the interference information further includes the information relating to the reliability degree.

In the present example embodiment, the output unit 23 outputs the interference information to the display means 60. Further, in the present example embodiment, the interference information is image information for causing the display means 60 to display the image indicating the information relating to the estimation result of radio interference. In other words, the output unit 23 outputs the interference information to the display means 60, and thus the display means 60 is caused to display the image indicating the information relating to the estimation result.

Next, examples of the estimation condition are described.

For example, in the estimation condition, the reception signal level is equal to or greater than the first threshold value, and the throughput is equal to or less than a second threshold value. This condition indicates that the throughput is reduced while the signal level is sufficient. In such a case, radio interference is highly likely to occur. In the estimation condition, a PER or a BER may be used in place of the throughput.

Further, for example, in the estimation condition, the reception signal level is equal to or greater than the first threshold value, and the SINR is equal to or greater than a third threshold value.

Further, for example, the estimation condition may be a condition based on a date and time. For example, it is assumed that it is found that an interference source passes by a certain wireless reception means at a specific time on a specific day, and radio interference occurs at the location position of the wireless reception means. In such a case, with regard to the wireless reception means, the estimation condition may be the specific time (time zone) on the specific day.

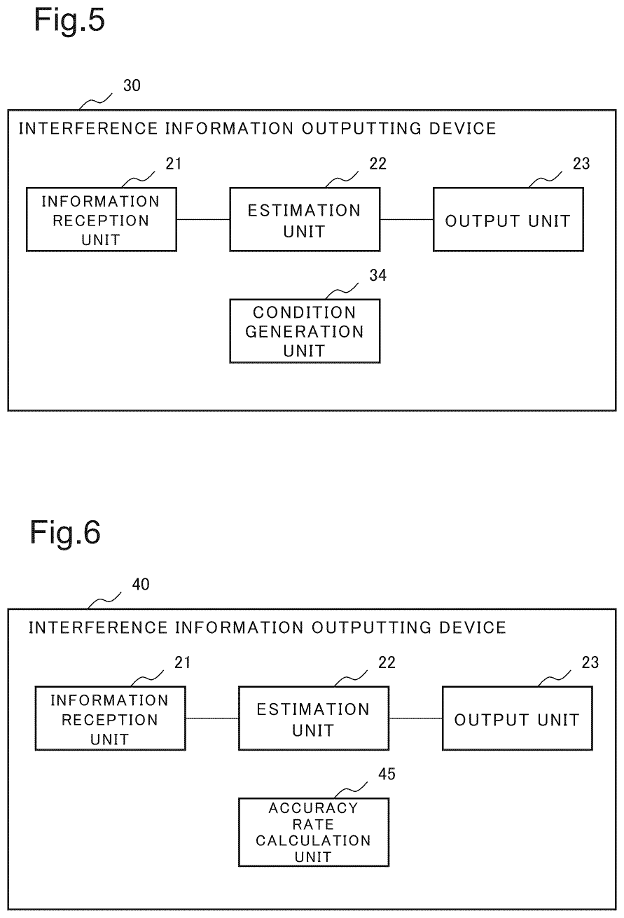

Further, the estimation condition may be generated based on a history of the estimation results in the past. For example, the estimation unit 22 causes a storage unit (omitted in illustration) to store information relating to a date and time when radio interference is estimated to occur at the location position of each wireless reception means 50-i. Further, a condition generation unit 34 generates a condition relating to a date and time when radio interference is estimated to occur, based on the history of the information relating to a date and time when radio interference is estimated to occur. The condition generation unit may be included inside the interference information outputting device, or may be provided outside of the interference information outputting device 20. Further, for example, the condition generation unit 34 may generate the estimation condition by machine learning. FIG. 5 illustrates a configuration example of an interference information outputting device 30 including the condition generation unit 34.

Further, the estimation condition may be acquired by combining two or more of the individual estimation conditions, which are described above, with each other. Hereinafter, the individual estimation condition is referred to as an individual condition. For example, the estimation condition may be fulfillment of any one or more of the individual conditions, or may be fulfillment of the predetermined number or more of the individual conditions.

Next, an example of a specific example of calculating the reliability degree is described.

For example, the estimation unit 22 executes the estimation at a regular interval (for example, one second). Further, with regard to the location position of the wireless reception means 50-i, the estimation unit 22 increases the reliability degree of the location position as the number of consecutive times the result of the estimation is affirmative is increased. In this manner, the reliability degree is low when the throughput is temporarily reduced, and the reliability degree is high when radio interference continuously occurs.

Further, for example, when the estimation condition is fulfillment of the predetermined number or more of individual conditions, the estimation unit 22 increases the reliability degree as the number of individual conditions being fulfilled is increased.

Further, the estimation unit 22 may increase the reliability degree as an accuracy rate of the individual condition being satisfied is higher. The accuracy rate is associated with each of the individual conditions. The accuracy rate is a ratio of the number of times radio interference actually occurs when the individual condition is fulfilled with respect to the number of times the individual condition is fulfilled. The accuracy rate may be set in advance in the interference information outputting device 20.

Further, the accuracy rate may be calculated by an accuracy rate calculation unit 45. FIG. 6 illustrates a configuration example of an interference information outputting device 40 including the accuracy rate calculation unit 45. For example, when it is estimated that radio interference occur, the estimation unit 22 causes the storage unit to store information relating to the location position of the wireless reception means 50-i and the date and time at which radio interference occurs and information indicating the individual condition on which the estimation is based. Further, the accuracy rate calculation unit 45 receives accurate information being information relating to a date and time, and a location where radio interference actually occurs. Further, the accuracy rate calculation unit 45 calculates the accuracy rate of the individual condition, based on the information being stored in the storage unit and the accurate information. The accurate information is input from the outside of the interference information outputting device 40 to the interference information outputting device 40.

Next, specific examples of the image the output unit 23 causes the display means 60 to display are described.

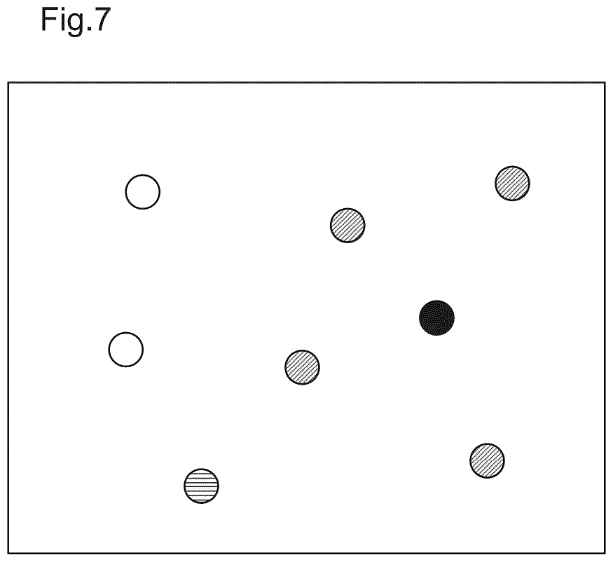

For example, the image may display the estimation result of radio interference at the position of the wireless reception means 50-i on a map. In this case, the estimation result of radio interference may be differentiated according to presence or absence of occurrence of radio interference and the reliability degree, and may be displayed in the image. FIG. 7 is a diagram illustrating an example of the display image. For example, as illustrated in FIG. 7, in the image, a screen item indicating the wireless reception means 50-i is arranged at the position of the wireless reception means 50-i on the map. Further, the display format of the screen item, such as a color and a color shade, is differentiated according to the estimation result of presence or absence of radio interference and the reliability degree, and is displayed.

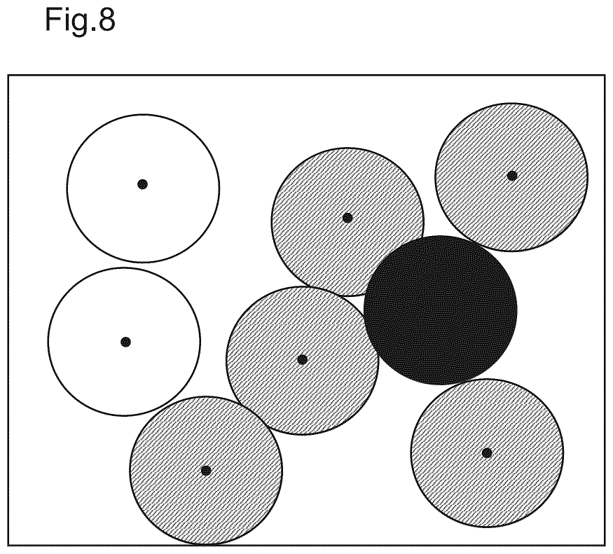

Further, the image may display the estimation result of radio interference in a region in the vicinity of the wireless reception means 50-i on the map. Further, display of the estimation result of radio interference may be differentiated according to the estimation result relating to presence or absence of radio interference and the reliability degree. FIG. 8 is a diagram illustrating an example of the display image. In FIG. 8, the block dot indicates the location position of the wireless reception means 50-i. Further, the circle indicates the estimation result of radio interference. Further, the display format of the circle indicating the estimation result, such as a color and a color shade, is differentiated according to the estimation result of presence or absence of radio interference and the reliability degree, and is displayed.

In FIG. 8, the radius of the circle indicating the estimation result may be fixed or varied. Further, the region indicating the estimation result may be a region having a freely-selected shape instead of the circle. For example, the region indicating the estimation result may be a range in which the wireless reception means 50-i can receive the wireless signal. Further, the region indicating the estimation result may be indicated by a circle having a radius equal to a distance to another wireless reception means at the nearest location. Further, when the regions are displayed in an overlapping manner, the regions may be displayed according to a rule such as prioritizing one with a higher reliability degree and prioritizing one with a lower reliability degree.

Further, in addition to a display indicating the estimation result and the reliability degree, a display indicating an arrival direction of an interference wave may be given in the region indicating the estimation result. For example, the estimation result and the reliability degree are displayed by different colors, and an arrival direction of an interference wave may be displayed by a color shade. For example, the region may be displayed while indicating an arrival direction of an interference wave with a dark color, and the color may be lighter as moving away from the arrival direction. The arrival direction of the interference wave can be estimated by the wireless reception means 50-i when the wireless reception means 50-i uses a variable directional antenna or uses two or more directional antennas. A freely-selected method may be used for the estimation of the arrival direction.

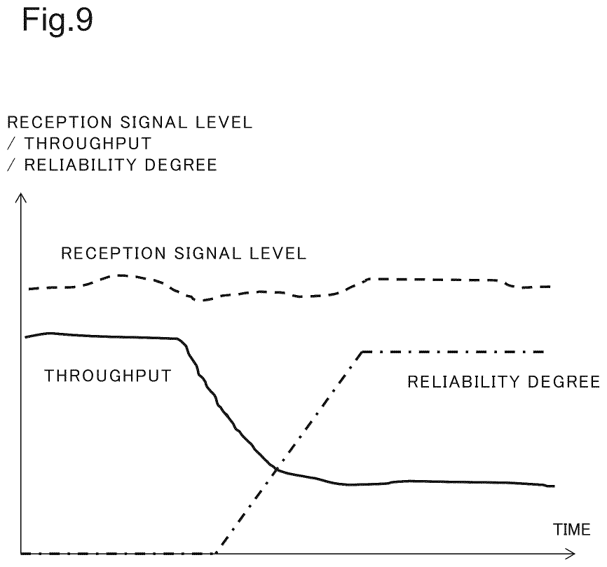

Further, the image the output unit 23 causes the display means 60 to display may display the signal information and the reliability degree at the predetermined location position. FIG. 9 illustrates an example of the display image. FIG. 9 illustrates the reception signal level and the throughput as the signal information. The horizontal axis indicates time. Further, the reliability degree may be displayed by colors indicating the reception signal level, the throughput, the display region, and the like, instead of a graph. For example, the throughput may be displayed in a normal color when it is estimated that radio interference does not occur, and may be displayed in a color according to the reliability degree when it is estimated that radio interference occurs. A user may be allowed to specify information to display, among information pieces relating to the location positions of the wireless reception means 50-i.

Further, the output unit 23 may output the interference information to an output destination other than the display means 60. For example, the interference information may be data including information relating to the result of the estimation and the reliability degree with regard to each wireless reception means 50-i. Further, the interference information may include information (information such as a latitude and a longitude) relating to the location position of the wireless reception means 50-i or information relating to an arrival direction of an interference wave. Further, the information being included in the interference information may be sorted in order of the reliability degree, from highest to lowest.

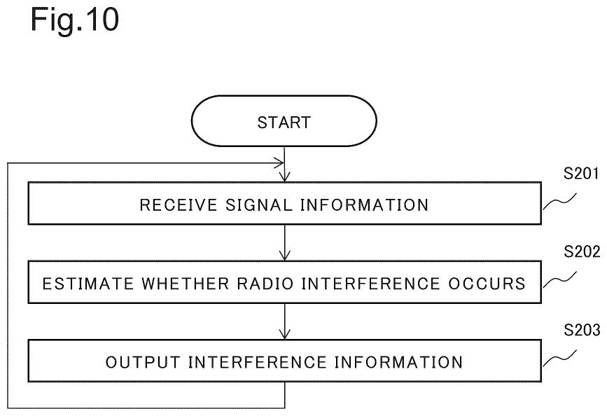

Next, FIG. 10 illustrates an example of an operation flow of the interference information outputting device 20 according to the present example embodiment.

The information reception unit 11 receives the signal information (step S201). In the present example embodiment, the signal information is transmitted from the wireless reception means 50-i at the regular interval.

The estimation unit 12 executes the estimation on whether radio interference occurs at the location position at which the wireless reception means is located. Further, the estimation unit 12 further calculates the reliability degree indicating a degree of accuracy of the estimation when the result of the estimation is affirmative (step S202). In the present example embodiment, the estimation unit 12 executes the estimation and the calculation of the reliability degree at the regular interval.

The output unit 13 outputs the interference information (step S203). In the present example embodiment, the output unit 13 outputs the interference information at the regular interval. The output unit 13 may output the interference information at a freely-selected timing instead of at the regular interval. For example, when a request is received from an apparatus being an output destination of the interference information, or radio interference is estimated to occur, the output unit 13 may output the interference information.

As described above, in the second example embodiment of the present invention, the interference information outputting device 20 includes the information reception unit 21, the estimation unit 22, and the output unit 23. The information reception unit 21 receives the signal information. The signal information is the information relating to quality of the reception signal being the wireless signal being received by the wireless reception means for receiving a wireless signal. The estimation unit 22 executes the estimation on whether radio interference occurs at the location position at which the wireless reception means is located. Further, the estimation unit 22 executes the estimation, based on the estimation condition. The estimation condition is a condition that is fulfilled when radio interference occurs. Further, the estimation condition includes the condition relating to the signal information. Further, the estimation unit 22 further calculates the reliability degree indicating a degree of accuracy of the estimation when the result of the estimation is affirmative. The output unit 23 outputs the interference information being information relating to radio interference. The interference information includes the information relating to the location position and the information relating to the result of the estimation, and includes the information relating to the reliability degree when the result of the estimation is affirmative. In this manner, the interference information outputting device 20 outputs the information relating to the result of the estimation on whether radio interference occurs at the location position of the wireless reception means and the information relating to the reliability degree of the estimation. The information relating to the estimation result is output from the interference information outputting device 20, and hence an investigator can easily determine whether the degradation of service quality is caused by radio interference by referring to the information being output. Further, the information being output from the interference information outputting device 20 includes the information relating to the reliability degree of the estimation, and hence determination by an investigator is facilitated more. Thus, the information for facilitating determination on whether the degradation of service quality is caused by radio interference can be output.

Further, the estimation unit 22 according to the present example embodiment executes the estimation at the regular interval, and increases the reliability degree of the location position as the number of consecutive times the result of the estimation on the location position is affirmative is increased. With this, it is estimated that radio interference continuously, the reliability degree when radio interference is highly likely to occur is high, and hence determination by an investigator can be facilitated more.

Further, in the present example embodiment, the estimation condition may be fulfillment of the predetermined number or more of individual conditions. Further, the estimation unit 22 increases the reliability degree as the number of individual conditions being fulfilled is increased. With this, a large number of individual conditions are fulfilled, the reliability degree when radio interference is highly likely to occur is high, and hence determination by an investigator can be facilitated more.

Further, in the present example embodiment, the estimation condition may be fulfillment of the predetermined number or more of individual conditions. Further, the estimation unit 22 increases the reliability degree, based on the accuracy rate being associated with each of the individual conditions, as the accuracy rate of the individual condition being satisfied is higher. The accuracy rate is a ratio of the number of times radio interference actually occurs when the individual condition is fulfilled with respect to the number of times the individual condition is fulfilled. With this, the individual condition with a high accuracy rate is fulfilled, the reliability degree when radio interference is highly likely to occur is high, and hence determination by an investigator can be facilitated more.

Further, the interference information outputting device 40 according to the present example embodiment further includes the accuracy rate calculation unit 45 that calculates the accuracy rate. The accuracy rate calculation unit 45 calculates the accuracy rate, based on the accurate information being information relating to a date and time, and a location where radio interference actually occurs, the information relating to the location position, and a date and time at which radio interference is estimated to occur, and the information indicating the individual condition on which the estimation is based. With this, the calculation of the accuracy rate can be achieved by the interference information outputting device 40.

Further, in the present example embodiment, the output unit 23 outputs the interference information to the display means 60 for displaying an image. Further, the interference information is the image information for causing the display means 60 to display an image. The image displays the result of the estimation at the position of the wireless reception means 50-i on the map. The result of the estimation is differentiated according to the reliability degree, and is displayed in the image. With this, an investigator can easily grasp a location where radio interference is highly likely to occur.

Further, in the present example embodiment, the output unit 23 outputs the interference information to the display means 60 for displaying an image. The interference information is the image information for causing the display means 60 to display an image. The image displays the signal information and the reliability degree that relate to the predetermined location position. With this, an investigator can grasp the possibility of occurrence of radio interference and the signal information relating thereto.

Further, in the present example embodiment, the signal information includes the wireless information being information relating to wireless characteristics of the reception signal and the reception information being information relating to quality of a reception status of the reception signal. With this, the estimation on whether radio interference occurs can be facilitated.

### Hardware Configuration Example

Description is made on a configuration example of hardware resources for achieving the above-mentioned interference information outputting device (10, 20) according to each of the exemplary embodiments of the present invention by using one information processing apparatus (computer). The interference information outputting device may be achieved physically or functionally by using at least two information processing apparatuses. Further, the interference information outputting device may be achieved as a dedicated apparatus. Further, only some of the functions of the interference information outputting device may be achieved by using the information processing apparatus.

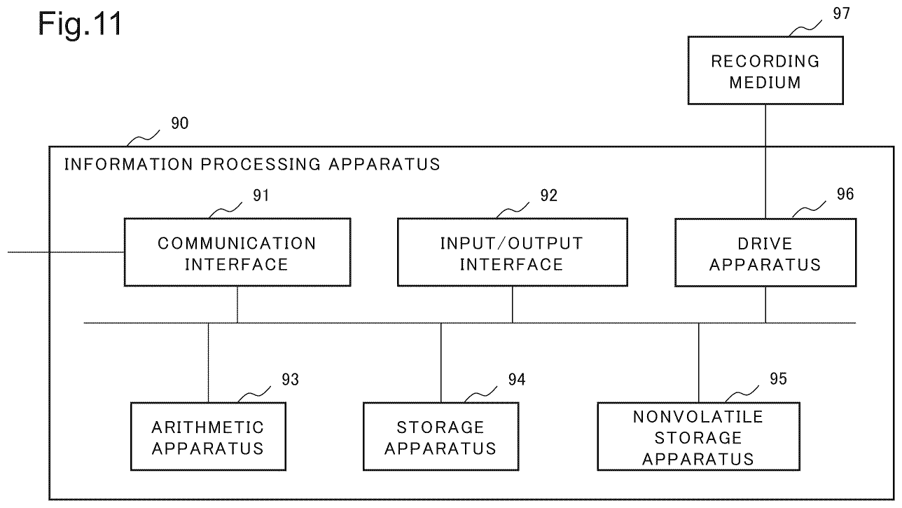

FIG. 11 is a diagram schematically illustrating a hardware configuration example of an information processing apparatus capable of achieving the interference information outputting device according to each of the exemplary embodiments of the present invention. An information processing apparatus 90 includes a communication interface 91, an input/output interface 92, an arithmetic apparatus 93, a storage apparatus 94, a nonvolatile storage apparatus 95, and a drive apparatus 96.

For example, the information reception unit 11 and the output unit 13 in FIG. 1 can be achieved by the communication interface 91 and the arithmetic apparatus, and the estimation unit 12 can be achieved by the arithmetic apparatus 93.

The communication interface 91 is a communication means for causing the interference information outputting device of each of the exemplary embodiments to communicate with an external apparatus in a wired and/or wireless manner. When the interference information outputting device is achieved by using at least two information processing apparatuses, those apparatuses may be connected to each other in a communicable manner via the communication interface 91.

The input/output interface 92 is a human machine interface including a keyboard being an example of an input device, a display being an output device, and the like.

The arithmetic apparatus 93 is achieved by an arithmetic processing apparatus such as a general central processing unit (CPU) and a microprocessor and a plurality of electric circuits. For example, the arithmetic apparatus 93 is capable of reading various programs stored in the nonvolatile storage apparatus 95 into the storage apparatus 94 and executing processing according to the read program.

The storage apparatus 94 is a memory apparatus such as a random access memory (RAM) to which the arithmetic apparatus 93 can refer, and stores a program, various data, and the like. The storage apparatus 94 may be a volatile memory apparatus.

For example, the nonvolatile storage apparatus 95 is a nonvolatile storage apparatus such as a read only memory (ROM) and a flash memory, and is capable of storing various programs, data, and the like.

The drive apparatus 96 is an apparatus that execute processing of reading and writing data with respect to a recording medium 97, which is described later, for example.

For example, the recording medium 97 is a freely selected recording medium capable of recording data, such as an optical disk, a magneto-optical disk, and a semi-conductor flash memory.

For example, each of the exemplary embodiments of the present invention may be achieved by configuring the interference information outputting device by the information processing apparatus 90 illustrated in FIG. 11 and supplying a program for achieving the functions described in each of the above-mentioned exemplary embodiments to the interference information outputting device.

In this case, the program supplied to the interference information outputting device is executed by the arithmetic apparatus 93, and thus the exemplary embodiments can be achieved. Further, some of the functions instead of all the functions of the interference information outputting device may be configured by the information processing apparatus 90.

Moreover, the above-mentioned program is stored in the recording medium 97, and the interference information outputting device may be configured in such a way that the above-mentioned program is stored as appropriate in the nonvolatile storage apparatus 95 at the time of shipping or operating the interference information outputting device. In this case, as the method of supplying the above-mentioned program, there may be adopted a method of installing the program in the interference information outputting device by using an appropriate jig at the time of manufacturing before shipping or at the time of operation. Further, as the method of supplying the above-mentioned program, there may be adopted a general procedure such as a method of downloading the program from the outside via a communication line such as the Internet.

The whole or a part of the example embodiments described above can be described as, but not limited to, the following Supplementary Notes.

### (Supplementary Note 1)

An interference information outputting device that is connected to a wireless reception means for receiving a wireless signal, the interference information outputting device comprising:
an information reception means for receiving signal information from the wireless reception means, the signal information being information relating to quality of a reception signal being the wireless signal received by the wireless reception means;
an estimation means for estimating whether radio interference occurs at a location position at which the wireless reception means is located, based on an estimation condition being a condition that is fulfilled when radio interference occurs; and
an output means for outputting interference information being information relating to radio interference, in which,
when a result of the estimation is affirmative, the estimation means further calculates a reliability degree indicating a degree of accuracy of the estimation,
the estimation condition includes a condition relating to the signal information, and
the interference information includes information relating to the location position and information relating to the result of the estimation, and includes information relating to the reliability degree when the result of the estimation is affirmative.

### (Supplementary Note 2)

The interference information outputting device according to Supplementary Note 1, in which
the estimation means executes the estimation at a predetermined interval, and increases the reliability degree of the location position as a number of consecutive times when the result of the estimation at the location position is affirmative is increased.

### (Supplementary Note 3)

The interference information outputting device according to Supplementary Note 1 or 2, in which
the estimation condition refers to fulfillment of a predetermined number or more of individual conditions, and
the estimation means increases the reliability degree as a number of the individual conditions being fulfilled is increased.

### (Supplementary Note 4)

The interference information outputting device according to any one of Supplementary Notes 1 to 3, in which
the estimation condition refers to fulfillment of a predetermined number or more of individual conditions,
the estimation means increases the reliability degree, based on an accuracy rate being associated with each of the individual conditions, as the accuracy rate of the individual condition being fulfilled is higher, and
the accuracy rate is a ratio of a number of times radio interference actually occurs when the individual condition is fulfilled with respect to a number of times the individual condition is fulfilled.

### (Supplementary Note 5)

The interference information outputting device according to Supplementary Note 4, further comprising:
an accuracy rate calculation means for calculating the accuracy rate, in which
the accuracy rate calculation means calculates the accuracy rate, based on accurate information being information relating to a date and time and a location when and where radio interference actually occurs, information relating to the location position and a date and time where and when radio interference is estimated to occur, and information indicating the individual condition on which the estimation is based.

### (Supplementary Note 6)

The interference information outputting device according to any one of Supplementary Notes 1 to 5, in which
the output means outputs the interference information to a display means for displaying an image,
the interference information is image information for causing the display means to display the image,
the image displays the result of the estimation at a position of the wireless reception means on a map, and
the result of the estimation is differentiated according to the reliability degree, and is displayed in the image.

### (Supplementary Note 7)

The interference information outputting device according to any one of Supplementary Notes 1 to 5, in which
the output means outputs the interference information to a display means for displaying an image,
the interference information is image information for causing the display means to display the image, and
the image displays the signal information and the reliability degree in relation to the location position being predetermined.

### (Supplementary Note 8)

The interference information outputting device according to Supplementary Note 1, in which
the signal information includes wireless information being information relating to wireless characteristics of the reception signal and reception information being information relating to quality of a reception status of the reception signal.

### (Supplementary Note 9)

An interference information outputting method of an interference information outputting device that is connected to a wireless reception means for receiving a wireless signal, the interference information outputting method comprising:
receiving signal information from the wireless reception means, the signal information being information relating to quality of a reception signal being the wireless signal received by the wireless reception means;
estimating whether radio interference occurs at a location position at which the wireless reception means is located, based on an estimation condition being a condition that is fulfilled when radio interference occurs, the estimation condition including a condition relating to the signal information;
further calculating a reliability degree indicating a degree of accuracy of the estimation when a result of the estimation is affirmative;
outputting interference information being information relating to radio interference, in which
the interference information includes information relating to the location position and information relating to the result of the estimation, and includes information relating to the reliability degree when the result of the estimation is affirmative.

### (Supplementary Note 10)

The interference information outputting method according to Supplementary Note 9, in which
the estimation is executed at a predetermined interval, and the reliability degree of the location position is increased as a number of consecutive times when the result of the estimation at the location position is affirmative is increased.

### (Supplementary Note 11)

The interference information outputting method according to Supplementary Note 9 or 10, in which
the estimation condition refers to fulfillment of a predetermined number or more of individual conditions, and
the reliability degree is increased as a number of the individual conditions being fulfilled is increased.

### (Supplementary Note 12)

The interference information outputting method according to any one of Supplementary Notes 9 to 11, in which
the estimation condition refers to fulfillment of a predetermined number or more of individual conditions,
the reliability degree is increased based on an accuracy rate being associated with each of the individual conditions, as the accuracy rate of the individual condition being fulfilled is high, and
the accuracy rate is a ratio of a number of times radio interference actually occurs when the individual condition is fulfilled with respect to a number of times the individual condition is fulfilled.

### (Supplementary Note 13)

The interference information outputting method according to Supplementary Note 12, in which
the accuracy rate is calculated based on accurate information being information relating to a date and time and a location when and where radio interference actually occurs, information relating to the location position and a date and time where and when radio interference is estimated to occur, and information indicating the individual condition on which the estimation is based.

### (Supplementary Note 14)

The interference information outputting method according to any one of Supplementary Notes 9 to 13, in which
the interference information is output to a display means for displaying an image,
the interference information is image information for causing the display means to display the image,
the image displays the result of the estimation at a position of the wireless reception means on a map, and
the result of the estimation is differentiated according to the reliability degree, and is displayed in the image.

### (Supplementary Note 15)

The interference information outputting method according to any one of Supplementary Notes 9 to 13, in which
the interference information is output to a display means for displaying an image,
the interference information is information for causing the display means to display the image,
the image displays the signal information and the reliability degree in relation to the location position being predetermined.

### (Supplementary Note 16)

The interference information outputting method according to Supplementary Note 9, in which
the signal information includes wireless information being information relating to wireless characteristics of the reception signal and reception information being information relating to quality of a reception status of the reception signal.

### (Supplementary Note 17)

A computer-readable recording medium recording an interference information outputting program causing a computer to achieve:
an information reception function of receiving signal information from a wireless reception means, the signal information being information relating to quality of a reception signal being a wireless signal received by the wireless reception means for receiving a wireless signal;
an estimation function of estimating whether radio interference occurs at a location position at which the wireless reception means is located, based on an estimation condition being a condition that is fulfilled when radio interference occurs; and
an output function of outputting interference information being information relating to radio interference, in which
when a result of the estimation is affirmative, the estimation function further calculates a reliability degree indicating a degree of accuracy of the estimation,
the estimation condition includes a condition relating to the signal information, and
the interference information includes information relating to the location position and information relating to the result of the estimation, and includes information relating to the reliability degree when the result of the estimation is affirmative.

### (Supplementary Note 18)

The computer-readable recording medium recording an interference information outputting program according to Supplementary Note 17, in which
the estimation function executes the estimation at a predetermined interval, and increases the reliability degree of the location position as a number of consecutive times when the result of the estimation at the location position is affirmative is increased.

### (Supplementary Note 19)

The computer-readable recording medium recording an interference information outputting program according to Supplementary Note 17 or 18 in which
the estimation condition refers to fulfillment of a predetermined number or more of individual conditions, and
the estimation function increases the reliability degree as a number of the individual conditions being fulfilled is increased.

### (Supplementary Note 20)

The computer-readable recording medium recording an interference information outputting program according to any one of Supplementary Notes 17 to 19, in which
the estimation condition refers to fulfillment of a predetermined number or more of individual conditions,
the estimation function increases the reliability degree, based on an accuracy rate being associated with each of the individual conditions, as the accuracy rate of the individual condition being fulfilled is higher, and
the accuracy rate is a ratio of a number of times radio interference actually occurs when the individual condition is fulfilled with respect to a number of times the individual condition is fulfilled.

### (Supplementary Note 21)

The computer-readable recording medium recording an interference information outputting program according to Supplementary Note 20, further causing a computer to achieve:
an accuracy rate calculation function of calculating the accuracy rate, in which
the accuracy rate calculation function calculates the accuracy rate, based on accurate information being information relating to a date and time and a location when and where radio interference actually occurs, information relating to the location position and a date and time where and when radio interference is estimated to occur, and information indicating the individual condition on which the estimation is based.

### (Supplementary Note 22)

The computer-readable recording medium recording an interference information outputting program according to any one of Supplementary Notes 17 to 21, in which
the output function outputs the interference information to a display means for displaying an image,
the interference information is image information for causing the display means to display the image,
the image displays the result of the estimation at a position of the wireless reception means on a map, and
the result of the estimation is differentiated according to the reliability degree, and is displayed in the image.

### (Supplementary Note 23)

The computer-readable recording medium recording an interference information outputting program according to any one of Supplementary Notes 17 to 21, in which
the output function outputs the interference information to a display means for displaying an image,
the interference information is image information for causing the display means to display the image,
the image displays the signal information and the reliability degree in relation to the location position being predetermined.

### (Supplementary Note 24)

The computer-readable recording medium recording an interference information outputting program according to Supplementary note 17, in which
the signal information includes wireless information being information relating to wireless characteristics of the reception signal and reception information being information relating to quality of a reception status of the reception signal.

### (Supplementary Note 25)

An interference information outputting system including:
an information reception means for receiving, from a wireless reception means, signal information being information relating to quality of a reception signal being a wireless signal received by the wireless reception means for receiving a wireless signal;
an estimation means for estimating whether radio interference occurs at a location position at which the wireless reception means is located, based on an estimation condition being a condition that is fulfilled when radio interference occurs; and
an output means for outputting interference information being information relating to radio interference, in which,
when a result of the estimation is affirmative, the estimation means further calculates a reliability degree indicating a degree of accuracy of the estimation,
the estimation condition includes a condition relating to the signal information, and
the interference information includes information relating to the location position and information relating to the result of the estimation, and includes information relating to the reliability degree when the result of the estimation is affirmative.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10, 20, 30, 40 Interference information outputting device
11, 21 Information reception unit
12, 22 Estimation unit
13, 23 Output unit
34 Condition generation unit
45 Accuracy rate calculation unit
50-i Wireless reception means
60 Display means
90 Information processing apparatus
91 Communication interface
92 Input/output interface
93 Arithmetic apparatus
94 Storage apparatus
95 Nonvolatile storage apparatus
96 Drive apparatus
97 Recording medium

What is claimed is:

1. An interference information outputting device that is connected to wireless reception means for receiving a wireless signal, the interference information outputting device comprising one or more memories storing instructions and one or more processors configured to execute the instructions to:
receive signal information from the wireless reception means, the signal information being information relating to quality of a reception signal being the wireless signal received by the wireless reception means;
estimate whether radio interference occurs at a location position at which the wireless reception means is located, based on an estimation condition being a condition that is fulfilled when radio interference occurs;
further calculate a reliability degree indicating a degree of accuracy of the estimation when a result of the estimation is affirmative; and
output interference information being information relating to radio interference, wherein;
the estimation condition includes a condition relating to the signal information, and
the interference information includes information relating to the location position and information relating to the result of the estimation, and includes information relating to the reliability degree when the result of the estimation is affirmative.

2. The interference information outputting device according to claim 1, wherein
the estimation is executed at a predetermined interval, and the reliability degree of the location position is increased as a number of consecutive times when the result of the estimation at the location position is affirmative is increased.

3. The interference information outputting device according to claim 1, wherein
the estimation condition refers to fulfillment of a predetermined number or more of individual conditions, and
the reliability degree is increased as a number of the individual conditions being fulfilled is increased.

4. The interference information outputting device according to claim 1, wherein
the estimation condition refers to fulfillment of a predetermined number or more of individual conditions,
the reliability degree is increased, based on an accuracy rate being associated with each of the individual conditions, as the accuracy rate of the individual condition being fulfilled is higher, and
the accuracy rate is a ratio of a number of times radio interference actually occurs when the individual condition is fulfilled with respect to a number of times the individual condition is fulfilled.

5. The interference information outputting device according to claim 4,
wherein
the processors are configured to execute the instructions to calculate the accuracy rate, based on accurate information being information relating to a date and time and a location when and where radio interference actually occurs, information relating to the location position and a date and time where and when radio interference is estimated to occur, and information indicating the individual condition on which the estimation is based.

6. The interference information outputting device according to claim 1, wherein
the interference information is output to display means for displaying an image,
the interference information is image information for causing the display means to display the image,
the image displays the result of the estimation at a position of the wireless reception means on a map, and
the result of the estimation is differentiated according to the reliability degree, and is displayed in the image.

7. The interference information outputting device according to claim 1, wherein
the interference information is output to display means for displaying an image,
the interference information is image information for causing the display means to display the image, and
the image displays the signal information and the reliability degree in relation to the location position being predetermined.

8. The interference information outputting device according to claim 1, wherein
the signal information includes wireless information being information relating to wireless characteristics of the reception signal and reception information being information relating to quality of a reception status of the reception signal.

9. An interference information outputting method of an interference information outputting device that is connected to wireless reception means for receiving a wireless signal, the interference information outputting method comprising:
receiving signal information from the wireless reception means, the signal information being information relating to quality of a reception signal being the wireless signal received by the wireless reception means;
estimating whether radio interference occurs at a location position at which the wireless reception means is located, based on an estimation condition being a condition that is fulfilled when radio interference occurs, the estimation condition including a condition relating to the signal information;
further calculating a reliability degree indicating a degree of accuracy of the estimation when a result of the estimation is affirmative;
outputting interference information being information relating to radio interference, wherein
the interference information includes information relating to the location position and information relating to the result of the estimation, and includes information relating to the reliability degree when the result of the estimation is affirmative.

10. The interference information outputting method according to claim 9, wherein
the estimation is executed at a predetermined interval, and the reliability degree of the location position is increased as a number of consecutive times when the result of the estimation at the location position is affirmative is increased.

11. The interference information outputting method according to claim 9, wherein
the estimation condition refers to fulfillment of a predetermined number or more of individual conditions, and
the reliability degree is increased as a number of the individual conditions being fulfilled is increased.

12. The interference information outputting method according to claim 9, wherein
the estimation condition refers to fulfillment of a predetermined number or more of individual conditions,
the reliability degree is increased based on an accuracy rate being associated with each of the individual conditions, as the accuracy rate of the individual condition being fulfilled is high, and
the accuracy rate is a ratio of a number of times radio interference actually occurs when the individual condition is fulfilled with respect to a number of times the individual condition is fulfilled.

13. The interference information outputting method according to claim 12, wherein
the accuracy rate is calculated based on accurate information being information relating to a date and time and a location when and where radio interference actually occurs, information relating to the location position and a date and time where and when radio interference is estimated to occur, and information indicating the individual condition on which the estimation is based.

14. The interference information outputting method according to claim 9, wherein
the interference information is output to display means for displaying an image,
the interference information is image information for causing the display means to display the image,
the image displays the result of the estimation at a position of the wireless reception means on a map, and
the result of the estimation is differentiated according to the reliability degree, and is displayed in the image.

15. The interference information outputting method according to claim 9, wherein
the interference information is output to display means for displaying an image,
the interference information is information for causing the display means to display the image,
the image displays the signal information and the reliability degree in relation to the location position being predetermined.

16. The interference information outputting method according to claim 9, wherein
the signal information includes wireless information being information relating to wireless characteristics of the reception signal and reception information being information relating to quality of a reception status of the reception signal.

17. A non-transitory computer-readable recording medium recording an interference information outputting program causing a computer to achieve:
an information reception function of receiving signal information from wireless reception means, the signal information being information relating to quality of a reception signal being a wireless signal received by the wireless reception means for receiving a wireless signal;
an estimation function of estimating whether radio interference occurs at a location position at which the wireless reception means is located, based on an estimation condition being a condition that is fulfilled when radio interference occurs; and
an output function of outputting interference information being information relating to radio interference, wherein,
when a result of the estimation is affirmative, the estimation function further calculates a reliability degree indicating a degree of accuracy of the estimation,
the estimation condition includes a condition relating to the signal information, and
the interference information includes information relating to the location position and information relating to the result of the estimation, and includes information relating to the reliability degree when the result of the estimation is affirmative.

18. The non-transitory computer-readable recording medium recording an interference information outputting program according to claim 17, wherein
the estimation function executes the estimation at a predetermined interval, and increases the reliability degree of the location position as a number of consecutive times when the result of the estimation at the location position is affirmative is increased.

19. The non-transitory computer-readable recording medium recording an interference information outputting program according to claim 17 wherein
the estimation condition refers to fulfillment of a predetermined number or more of individual conditions, and
the estimation function increases the reliability degree as a number of the individual conditions being fulfilled is increased.

20. The non-transitory computer-readable recording medium recording an interference information outputting program according to claim 17, wherein
the estimation condition refers to fulfillment of a predetermined number or more of individual conditions,
the estimation function increases the reliability degree, based on an accuracy rate being associated with each of the individual conditions, as the accuracy rate of the individual condition being fulfilled is higher, and
the accuracy rate is a ratio of a number of times radio interference actually occurs when the individual condition is fulfilled with respect to a number of times the individual condition is fulfilled.

21-25. (canceled)
